(19) United States
(12) Patent Application Publication
(10) Pub. No.: US 2024/0072473 A1
(43) Pub. Date: Feb. 29, 2024

(54) COATING ON A SURFACE TO TRANSMIT ELECTRICAL CURRENT

(71) Applicant: TE Connectivity Solutions GmbH, Schaffhausen (CH)

(72) Inventors: Isabell Buresch, Woert (DE); Jean-Claude Puippe, Châtel-St-Denis (CH)

(21) Appl. No.: 18/454,849

(22) Filed: Aug. 24, 2023

(30) Foreign Application Priority Data
Aug. 26, 2022 (EP) 22192362.6

(51) Int. Cl. H01R 13/03; B60L 53/16

(52) U.S. Cl. CPC H01R 13/03; B60L 53/16; H01R 2201/26; H02J 7/0045

(57) ABSTRACT

A coating on a surface of a substrate for transmitting electrical current in an automotive plug connection for charging an EV-battery and having layers of different microstructures and performances which extend at least essentially in parallel to the surface. The layers include at least one fine-grained intermediate layer containing silver grains exhibiting a nano-crystalline grain size having an average grain size below 1000 nanometers and containing graphite particles. The layers include at least one coarse-grained layer located adjacent to the fine-grained layer and containing silver grains exhibiting a grain size which is on average larger than that of the fine-grained layer.

### CROSS REFERENCE TO RELATED APPLICATIONS

This application claims the benefit of EP Application No. 22192362.6, filed on 26 Aug. 2022, the subject matter of which is herein incorporated by reference in its entirety.

### BACKGROUND OF THE INVENTION

The subject matter herein relates generally to a coating on a surface of a substrate.

High power charging (HPC) of EV-batteries is relying on ever increasing currents in order to reduce the charging time for a e.g. 100 kWh battery from 30 to 5 minutes, for example. To transmit electrical current, especially in HPC applications, to charge a drive battery, electric charging contacts are necessitated that can transmit high electrical currents (e.g. above 200 A) especially at high voltages (e.g. above 100 V, 200 V or 400 V) with a low contact resistance and can endure many mating cycles (e.g. at least 10.000, 20.000 or 40.000) without providing a remarkable increase in contact resistance. Charging contacts suffer from the wear behavior and the electrical contact resistance of the charging contact, possibly leading to Joulean heating and/or derating of the electrical current.

Silver (Ag) has been evolved as a promising material to be used as a coating on parts out of copper or copper alloys, providing a good electrical conductivity and wear behavior. The coating comprising silver may be provided by use of electro-deposition processes. However, silver or predominantly metallic (hard) silver alloys still undergo wear, due to mating cycles, especially when it comes 3000 or more mating cycles. Increasing the hardness of the coating by alloying the silver coating is known, but may increase the contact resistance in an unwanted manner. It is further known that graphite (C) particles may be added to a silver alloy to provide inherent lubrication to the coating. An increase in contact resistance can happen and is mostly related to the co-deposited organics. By increasing the thickness of the silver coating, wear behavior is enhanced, but costs increase unwantedly.

There is a need for cost effective and reliable charging contacts.

### BRIEF DESCRIPTION OF THE INVENTION

In an embodiment, a coating on a surface of a substrate is provided for transmitting electrical current in an automotive plug connection for charging an EV-battery. The coating includes layers of different microstructures and performances which extend at least essentially in parallel to the surface. The layers include at least one fine-grained intermediate layer containing silver grains exhibiting a nano-crystalline grain size having an average grain size below 1000 nanometers and containing graphite particles. The layers include at least one coarse-grained layer located adjacent to the fine-grained layer and containing silver grains exhibiting a grain size which is on average larger than that of the fine-grained layer.

In another embodiment, an electric charging contact is provided for use in an automotive plug connection. The electric charging contact includes a substrate having a surface and a coating on the surface. The coating includes layers of different microstructures and performances which extend at least essentially in parallel to the surface. The layers include at least one fine-grained intermediate layer containing silver grains exhibiting a nano-crystalline grain size having an average grain size below 1000 nanometers and containing graphite particles. The layers include at least one coarse-grained layer located adjacent to the fine-grained layer and containing silver grains exhibiting a grain size which is on average larger than that of the fine-grained layer.

In a further embodiment, an automotive charging connection is provided for charging a battery of an electric vehicle. The automotive charging connection includes one of a charging inlet configured to be fixed to the electric vehicle or a charging gun configured to be plugged into a charging inlet of the electric vehicle. The automotive charging connection includes an electric charging contact held by the charging inlet or the charging gun. The electric charging contact including a substrate having a surface and a coating on the surface. The coating includes layers of different microstructures and performances which extend at least essentially in parallel to the surface. The layers include at least one fine-grained intermediate layer containing silver grains exhibiting a nano-crystalline grain size having an average grain size below 1000 nanometers and containing graphite particles. The layers include at least one coarse-grained layer located adjacent to the fine-grained layer and containing silver grains exhibiting a grain size which is on average larger than that of the fine-grained layer.

### BRIEF DESCRIPTION OF THE DRAWINGS

FIG. 1A illustrates a cross section of a coating as per state of the art in SEM analysis in accordance with embodiments herein.

FIG. 1B illustrates a cross section of the coating as per state of the art in EBSD analysis in accordance with embodiments herein.

FIG. 2A illustrates a cross section of a coating according to an exemplary embodiment in SEM analysis in accordance with embodiments herein.

FIG. 2B illustrates a cross section of the coating according to an exemplary embodiment in EBSD analysis in accordance with embodiments herein.

FIG. 3A illustrates a FIB lamella of the coating according to an exemplary embodiment in SEM analyses in an overall view in accordance with embodiments herein.

FIG. 3B illustrates a FIB lamella of the coating according to an exemplary embodiment in SEM analyses in a region with fine-grained and coarse-grained layers in accordance with embodiments herein.

FIG. 3C illustrates a FIB lamella of the coating according to an exemplary embodiment in SEM analyses in a region with an outermost fine-grained surface layer in accordance with embodiments herein.

FIG. 4 illustrates an automotive charging connection including an electric charging contact having a coating in accordance with an exemplary embodiment.

### DETAILED DESCRIPTION OF THE INVENTION

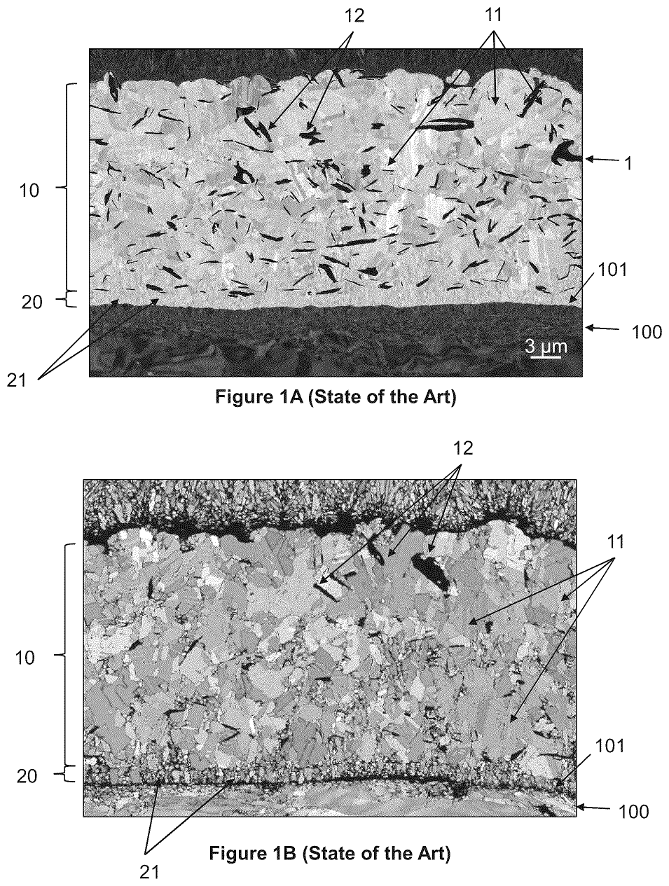

FIG. 1A shows a coating 1 on a surface 101 of a substrate 100 according to the state of the art. The coating 1 as per state of the art may be produced by use of electro-deposition, especially a rack plating process. The coating 1 is designed to transmit electrical current in an automotive plug connection for charging an EV-battery. The microstructure of the prior art coating 1 predominantly comprises two layers 10, 20 directly atop each other, one of which being an outermost surface layer 10 exhibiting randomly distributed silver grains 11 and embedded graphite particles 12. The graphite particles 12 are oriented randomly within the layer 10 and/or coating 1.

The other layer 20 in FIG. 1A is an adhesion layer that is adjacent to the base material 100 and is in direct contact with the outermost layer 10. The fine-grained layer 20 serves as an adhesion layer and consists of silver grains 21 and/or nickel grains and/or Cu-grains. The two layers 10, 20 run along and essentially in parallel to the substrate interface 101.

A Cu-flash may be located below the layer 20 and atop the substrate interface 101, not only in this state of the art example, but as well in combination with any coating 1.

It can be seen that the graphite particles 12 reach up to the surface of the outermost fine-grained surface layer 10, likely being responsible for a not closed surface of the coating 1 and the black finger/tray effect during handling and assembling. The coating 1 as per state of the art is rough and not “closed”.

FIG. 1B shows the coating 1 according to the state of the art in an EBSD analysis image, wherein the colors of the original microscopic image have been converted to a grey scale. Despite the lack in colors, it can be seen that the coating in the outermost surface layer 10 predominantly comprises a plurality of micro-crystalline silver grains 11, i.e., with a size above 0.5 up to 10 micrometers, and the graphite particles 12.

The fine-grained layer 20 directly under the outermost surface layer 10 and directly atop and running along the substrate interface 101 exhibits a nano-crystalline silver grain 21 size, i.e., with an average grain size below 1 or 0.5 micrometers.

In other words, the prior art consists of an outermost surface layer 10 and a fine-grained adhesion layer 20. The outermost surface layer 10 exhibits micro-crystalline grains (silver grains 11) and graphite particles 12, wherein the outermost surface 10 layer is located directly atop the fine-grained layer 20. The fine-grained layer 20 consists of nano-crystalline silver grains 21.

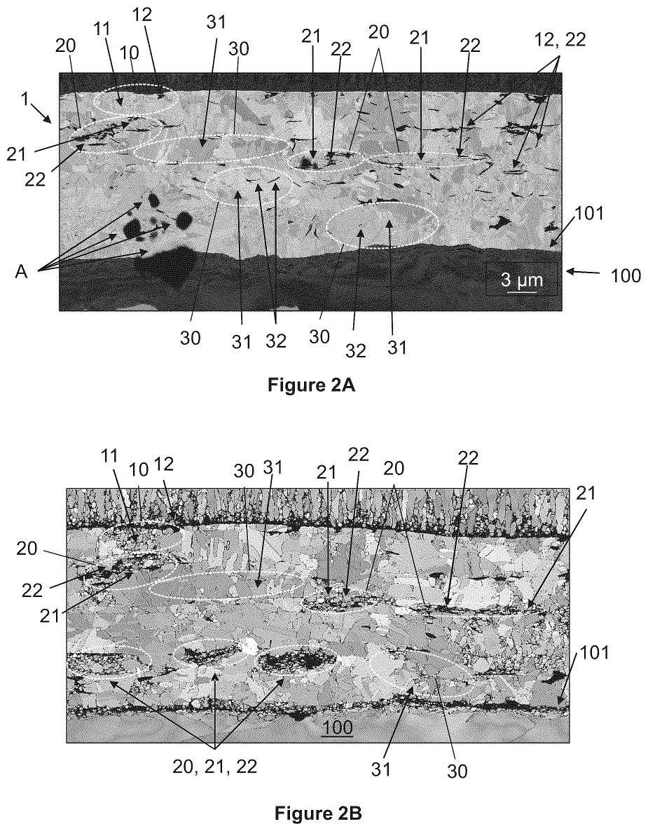

FIGS. 2A-B show a coating 1 on a surface 101 of a substrate 100 in accordance with an exemplary embodiment. In various embodiments, the coating 1 is used to transmit electrical current in an automotive plug connection for charging an EV-battery. However, the coating 1 may be used on substrates 100 used in different applications. The coating 1 has layers 10, 20, 30 of different microstructures and performances which are extended essentially in parallel to the surface 101. The coating 1 may be produced by use of electro-deposition with mechanical impact, where the mechanical impact may serve to crush graphite particles 12, 22, 32 during the electro-deposition process.

As compared to the state-of-the art an additional layer, for example an adhesion layer, and/or a Cu-flash, which may be deposited directly on the substrate, may also be provided.

At least partially, in FIGS. 2A-B there is at least one outermost fine-grained surface layer 10 which contains silver grains 11 exhibiting a nano-crystalline grain size with an average grain size below 1000 nanometers and above 300 nanometers, and which outermost fine-grained surface layer 10 further contains embedded graphite particles 12. The graphite particles 12 have a nano-scale size such as an average size at least below 1000 nanometers, in particular below 250 nanometers. The graphite particles 12 are spread along the layer 10 and the surface 101.

The coating 1 comprises at least one and possibly several intermediate fine-grained layers 20 containing silver grains 21 exhibiting a nano-crystalline grain size, such as an average grain size below 1000 nanometers and above 300 nanometers and containing embedded graphite particles 22, which may be oriented parallel to the surface 101 of the substrate 100. The graphite particles 22 have a nano-scale size such as an average size at least below 1000 nanometers. In various embodiments, the graphite particles have an average size below 250 nanometers. The graphite particles 22 are extended along the layer 20, such as parallel to the surface 101.

Further, the coating 1 of FIGS. 2A-B comprises at least one and possibly several coarse-grained regions and/or coarse-grained layers 30 located adjacent to at least one of the other layers 10, 20 and containing predominantly silver grains 31 (among some occurrences of embedded graphite particles 32) exhibiting a grain size which is on average, here at least an order of magnitude, larger than that of the fine-grained layer 20 and/or the outermost fine-grained surface layer 10. The silver grains 31 of the coarse-grained layers 30 serve as a matrix embedding intermediate fine-grained layers 20 followed by an outermost fine-grained surface layer 10, 20 which has a higher hardness and less ductility than the coarse silver grains 31. It is noted that FIG. 2A exhibits measurement artefacts A to be identified through their blurred borders.

In principle, the graphite particles 12, the graphite particles 22, and the graphite particles 32 may be the same graphite particles or at least similar ones, such as in terms of crystal-structure. In various embodiments, the graphite particles 12, 22, 32 may be different ones in terms of size.

The graphite particles 12 correspond to the outermost fine-grained surface layer 10. The graphite particles 22 correspond to the fine-grained layer 20. The graphite particles 32 correspond to the coarse-grained layer 30. As such, in the case the layers 10, 20, 30 cannot be distinguished sharply as it may be the case from process uncertainties from known coating processes, the correspondences of individual graphite particles 12, 22, 32 may fall differently. Essentially the same is noted analogously with regard to the silver grains 11, 21, 31, wherein silver grains 11 and 21 each correspond to the fine-grained layer 10 or the fine-grained layer 20, respectively and the silver grains 31 belong to the coarse-grained layer 30; however, the layers 10, 20, 30 may be unsharply distinguishable layers resulting from the issue discussed above.

In FIG. 2A-B, the outermost fine-grained surface layer 10 covers the whole surface in different thicknesses. The thicker part has an areal fraction of at least 10%, wherein merely the shown cross section is evaluated for this value of the areal fraction. The areal fraction with higher film thickness of the fine-grained layer may be different, such as higher, in other locations.

The crystal structure of the graphite particles 12, 22, 32, such as in the outermost fine-grained surface layer 10, in the intermediate fine-grained layer 20, and in the coarse-grained layer 30, may be hexagonal 2H. In various embodiments, two of the layers 30, 32 are stacked atop the substrate interface 101. In an exemplary embodiment, the coarse-grained layer 30 exhibits a micro-crystalline grain size (i.e., an average silver grain 31 size) at least above 1 micrometer and below 1000 micrometers. In various embodiments, the coarse-grained layer 30 exhibits a micro-crystalline grain size is below 5 micrometers.

It is evident in the comparison with the prior art coating 1 (FIGS. 1A-B) that the coating 1 (FIGS. 2A-B) differs in graphite particle 12, 22, 32 size, distribution and extension. The graphite particles 12, 22, 32 are extended predominantly in parallel to the surface 101 of the substrate 100. The silver grain 11, 21 size in the outermost fine-grained surface layer 10 and as well in the fine-grained layer 20 is on average smaller in comparison to the prior art of FIGS. 1A-B. Silver grains 11, 21, 31 in general are rather layered (FIGS. 2A-B) as opposed to the silver grains 11, 21 being randomly extended/grown epitaxial in the prior art (FIGS. 1A-B). The graphite particle 12, 22, 32 content is different (for example, lower) and the surface roughness values, e.g. Ra or Rz values, are lower (for example, the surface of the coating 1 is smoother) compared to the prior art.

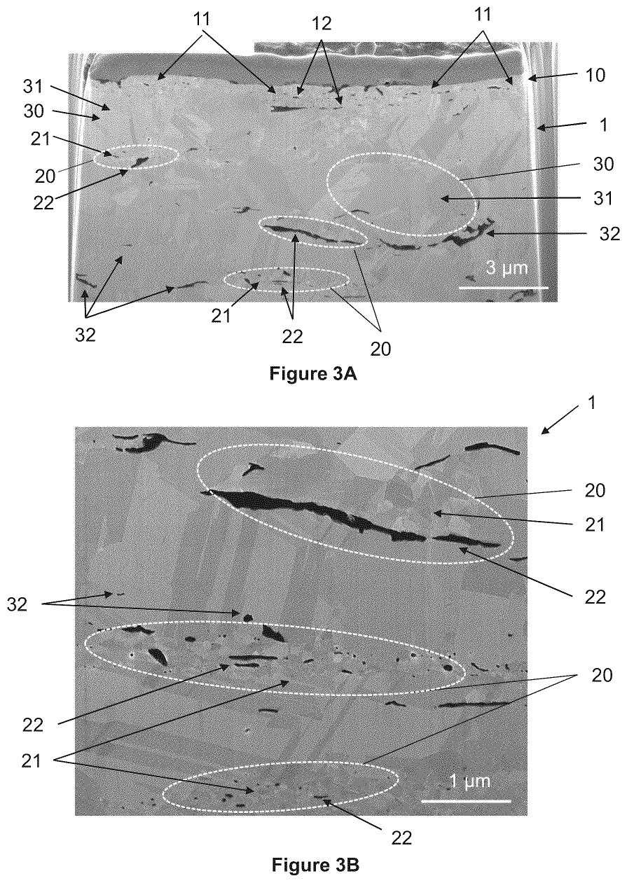

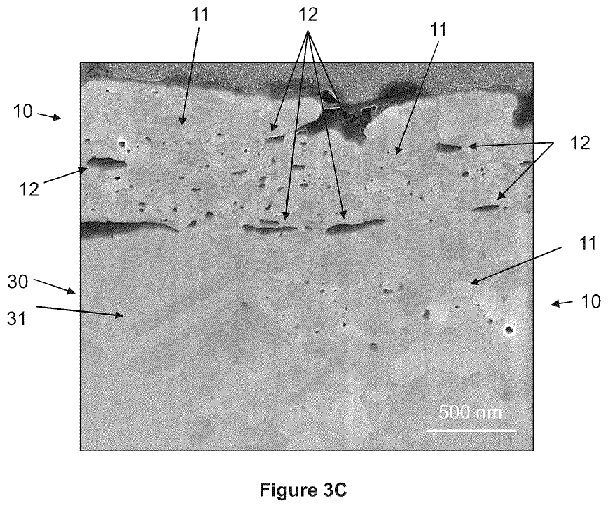

FIG. 3A-C shows a section seen in a scanning electron microscope (SEM) of a focused ion beam (FIB) cut of a coating on an electric charging contact for use in an automotive plug connection having a substrate 100 with a coating 1. The coating 1 has layers 10, 20, 30 of different microstructures which are extended generally in parallel to a surface 101 of the substrate 100. The surface/interface 101 is not shown in the FIGS. 3A-C, but is however extended in parallel to the bottom or top edge of the FIG. 3A-C.

As can be seen best in FIGS. 3A and 3B, there are fine-grained layers 20 containing graphite particles 22 exhibiting a nano-scale size, and containing silver grains 21 exhibiting a nano-crystalline grain size and there are coarse-grained layers 30 adjacent to the fine-grained layers 20 containing almost exclusively silver grains 31 (again, as in FIGS. 2A-B, among some graphite particles 32) exhibiting a silver grain 31 size which is on average larger than that of the fine-grained layer 20, in particular exhibiting a micro-crystalline grain size (grain size>1 μm). In addition, there is an outermost fine-grained surface layer 10 that contains silver grains 11 exhibiting a nano-crystalline grain size (in particular 300 nm<grain size<1000 nm) and that contains graphite particles 12 exhibiting a nano-scale size (in particular 1 nm<size<250 nm). Here, the outermost fine-grained surface layer 10 covers the coating with an areal fraction of more than 75%, in particular at least almost entirely.

In an exemplary embodiment, the crystal structure of the graphite particles 12, 22, 32 is hexagonal 2H.

In an exemplary embodiment, at least two of the layers 10, 20, 30 are stacked atop the surface 101.

The coating 1 is provided on the substrate 100, which may be made from copper or a copper alloy, Al- or an Al-alloy. In an exemplary embodiment, the coating 1 and the substrate 100 form an electric charging contact. In various embodiments, the contact may be at least partially rotationally symmetric, such as being cylindrical. In other various embodiments, the contact may be flat along a not shown horizontal axis under the surface 101.

In various embodiments, the electric charging contact is used as part of an automotive plug connection. The electric charging contact may be connected to a power cable or a busbar. The automotive plug connection includes a housing holding the contact, which may be made from polymer/resins. The automotive plug connection may include a shielding out of metal for the contact. The automotive plug connection may include additional features, such as for cooling the contact or other components such as the power cable or busbar.

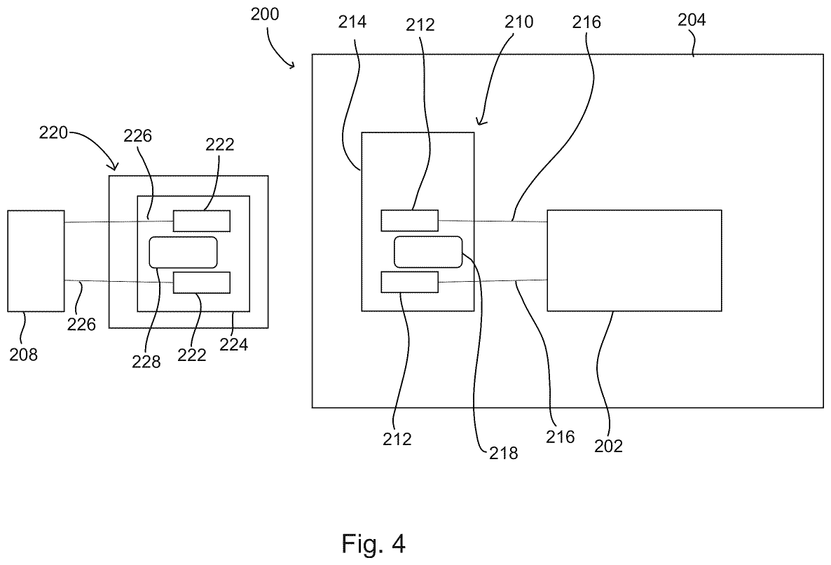

FIG. 4 illustrates an automotive charging connection 200 including electric charging contacts 212, 222 each having a coating, such as the coating 1 shown in FIGS. 2A-B and/or 3A-C in accordance with an exemplary embodiment. The automotive charging connection 200 is used for charging a battery 202 of an electric vehicle (EV) 204. The automotive charging connection 200 includes a charging inlet 210 on the EV 204 and a charging gun 220, which may be part of a charging station. The charging gun 220 is plugged into the charging inlet 210 to supply power for charging the battery 202.

The charging inlet 210 includes a housing 214 holding one or more of the electric charging contacts 212, which have the coating 1. In various embodiments, the electric charging contacts 212 are pin contacts; however, other types of contacts may be used in other embodiments, such as sockets, blades, spring beams, and the like. The electric charging contacts 212 are connected to conductors 216, such as power cables and/or busbars. The conductors 216 are connected to the battery 204. The housing 214 may hold at least a portion of the conductors 216. The housing 214 is made from a polymer or resin material. The charging inlet 210 may include shielding. The charging inlet 210 may include an active and/or passive cooling element 216, which is used to cool the contacts 212 and/or the conductors 216.

The charging gun 220 includes a housing 224 holding one or more of the electric charging contacts 222, which have the coating 1. In various embodiments, the electric charging contacts 222 are socket contacts; however, other types of contacts may be used in other embodiments, such as pins, blades, spring beams, and the like. The electric charging contacts 222 are connected to conductors 226, such as power cables and/or busbars. The conductors 226 are connected to a power supply 208. The housing 224 may hold at least a portion of the conductors 226. The housing 224 is made from a polymer or resin material. The charging gun 220 may include shielding. The charging gun 220 may include an active and/or passive cooling element 226, which is used to cool the contacts 222 and/or the conductors 226.

FIGS. 2A-B and/or 3A-C show a contact structure including harder nano-crystalline intermediate layers (outermost fine-grained surface layer 10 and fine-grained layer 20) at least partially surrounded by silver grains 31 (of the coarse-grained layer 30) exhibiting a micro-crystalline microstructure. The nano-crystalline boundary hardened top surface layer (outermost fine-grained surface layer 10) and/or the fine-grained layer 20 reduces wear, in particular with embedded graphite particles 12 and 22. There may be strictly extended (small) dispersoid particles (graphite particles 12 and 22 of the outermost fine-grained surface layer 10 or the fine-grained layer 20, respectively) reducing wear. There may be strictly extended (small) dispersoid particles (graphite particles 32 of the coarse-grained layer 30) reducing wear, although this effect may be subordinate to the graphite particles 12 and 22 of the outermost fine-grained surface layer 10 or the fine-grained layer 20, respectively. There may be a smooth and/or closed surface (especially the outermost fine-grained surface layer 10) of the coating 1 with embedded graphite particles 12, 22, 32 (especially graphite particles 12 of the outermost fine-grained surface layer 10) to avoid black finger/tray effect. There may be a specific grain extension and distribution relative to and generally in parallel to the surface 101 of the substrate 100. The coarse-grained layer 30 may have and/or surround graphite particles 32, which may be less graphite particles 32 than graphite particles 12 and/or 22 in the other layers 10, 20. In various embodiments, the coating 1 may not entirely consist out of a layered combination of outermost fine-grained surface layers 10, fine-grained layers 20 and coarse-grained layers 30, but rather of a layered microstructure where locally such layers 10, 20, 30 are identified in between and/or surrounded by silver grains 11, 21, 31 in general, and where graphite particles 12, 22, 32 may be present in between and/or surrounded by silver grains 11, 21, 31, such as even between coarse silver grains 31 of the coarse-grained layer 30.

In one embodiment, a coating 1 on a surface of a substrate is provided. In various embodiments, the coating 1 is used to transmit electrical current in an automotive plug connection (for example, as shown in FIG. 4), especially a termination for charging a battery of an electrically driven vehicle (EV).

One or more embodiments herein relate to an electric charging contact with a coating 1 for use in an automotive charging inlet and a charging gun.

One or more embodiments herein relate to an automotive charging connector, in particular comprising a charging inlet and/or a charging gun, including an electric charging contact with a coating 1, where the automotive charging connector is part of an automotive plug connection for charging an EV-battery.

The electric charging contacts in an automotive charging connection on an infrastructural side (which typically comprises the charging gun and which is the complement to the electrically driven vehicle typically having a charging inlet side) coated with a coating 1 as described further herein are used as the electric charging contacts provided to be part of the automotive charging connection.

One or more embodiments herein increase the wear behavior, stabilize the contact resistance at the level of pure Ag and decrease the costs by reducing the coating thickness to produce a coating 1 on a substrate. One or more embodiments herein provide an electric charging contact with the coating 1 and an automotive plug connector/charging inlet with the coating 1.

One or more embodiments herein relate to a coating 1 on a surface of a substrate, the coating 1 designed to transmit electrical current in an automotive plug connection for charging an EV-battery and having layers of different microstructures and performances which extend at least essentially in parallel to the surface. The coating 1 includes at least one layer containing silver grains exhibiting a nano-crystalline grain size, i.e., an average grain size below 1000 nanometers (nm), in particular above 1, 50 or 300 nanometers with graphite particles. The coating 1 includes at least one coarse-grained layer located adjacent to the fine-grained layer and containing predominantly or exclusively silver grains exhibiting a grain size, which is on average larger than that of the fine-grained layer.

Optionally, the layers of different microstructures and performances are particularly limited in thickness and are regularly thinner than the coating 1 in total; the same may be particularly true with regard to width. The layers of different microstructures and performances may each include a plurality of grains and/or phases, especially silver-based ones, especially different in arrangement, distribution, shape and/or size of the grains and/or phases. One or more of the layers may include graphite particles and/or other self-lubricated/self-lubricating particles like PTFE-particles or Sulfide-containing particles for example.

Optionally, the particles, i.e., particles mentioned herein such as the self-lubricating particles, graphite particles, or the like, are embedded within and/or between the layers. The particles may be surrounded by the microstructure and/or the layers. This serves for a good mechanical and physical connection of the particles to the layers.

Optionally, the fine-grained layer may be an intermediate layer or/and a top layer. For example, the intermediate fine-grained layer is located along the thickness of the coating 1 in parallel to the interface of the base material and coating 1, such as in between and/or beneath other layers.

Optionally, the coating 1 can be produced by electro-deposition with additional mechanical impact, where the mechanical impact may serve to crush the particles or apply high energy density locally affecting the growth/development of the microstructures so that both fine-grained and coarse-grained layers as well as the extension at least essentially in parallel to the surface may be achieved.

The “performance” of a layer relates to its mechanical and its electrical properties. As per a different microstructure of any layer typically a different performance of the layer results. In various embodiments, different layers throughout the coating 1 may include such different properties so that a synergetic effect from a combination may be achieved.

Optionally, the nano-crystalline grain size enables a strengthening effect and/or strength increase of the coating 1, in particular Hall-Petch strengthening, even in cases where the nano-crystalline grain size is not present across the entire coating 1. An increase in coating strength correlated to improved hardness values, such that the wear behavior during friction atop the coating 1 at a similar contact resistance is enhanced. The graphite additionally enables a self-lubricating effect of the coating 1 which is useful in electric plug connections with high mating cycle requirements, in particular HPC applications, further reducing/limiting wear behavior at a low contact resistance. From the spread essentially in parallel to the surface, which is the mating direction, it results advantageously that the wear behavior is further increased, since in a top view on the coating 1 a larger area atop the surface of the substrate is covered with coating material, e.g. layers, of increased hardness with nano-crystalline grains. In various embodiments, the surface becomes smoother compared to prior art.

One or more embodiments herein provide that there is no or at least a lot less wear during 20,000-50,000 mating cycles compared to state of the art coatings using silver and graphite at a lower coating thickness. In various embodiments, the coating 1 enables fast charging without derating of the current within e.g. 5 min. and/or a lifetime durability of the coated contacts and sockets at lower cost. The problematic black finger/black tray effect is almost eliminated due to the smooth surface. In various embodiments, the coating 1 provides enhanced sustainability.

One or more embodiments herein enable a reduction in coating thickness compared to the state of the art, especially compared to rack plating. This not only saves production time, but also necessitates less electrolyte in electro-deposition and less noble metal use. This as well is cost saving and sustainability increasing.

In various embodiments, at least one outermost fine-grained surface layer containing silver grains may be provided. The outermost fine-grained surface layer is particularly located above the remaining layers and/or constituents of the coating 1. The wear behavior of the surface of the coating 1 may be enhanced locally or at least essentially across the entire or almost the entire surface of the coating 1.

In various embodiments, the outermost fine-grained surface layer, being the top surface layer, may exhibit a nano-crystalline grain size, which particularly means that an average grain size is at least below 1000 nanometers and/or at least above 1 nanometer, in particular above 300 nanometers, in order to further enhance wear behavior especially in case of a new coating 1 to be used during transmission of electrical current.

Optionally, if the outermost fine-grained surface layer contains especially randomly distributed graphite particles, the self-lubricating effect takes place.

In various embodiments, the graphite particles of the outermost fine-grained surface layer may have a nano-scale size, which particularly means that an average graphite particle size is at least below 1000 nanometers and/or at least above 1 nanometer, in particular below 750, 500 or 250 nanometers.

In various embodiments, the graphite particles are embedded in the fine-grained layers and in the outermost fine-grained surface layer in order to stabilize the position of the particles relative to the layers.

In various embodiments, the graphite particles, especially of the outermost fine-grained surface layer, are extended and/or distributed at least essentially in parallel to and/or along the surface and/or at least one of the layers.

One or more embodiments herein provide that if the outermost fine-grained surface layer covers the surface at least essentially or with a thickness fraction of at least 1%, 5%, 10%, 25%, 50%, 75% or more, the coating 1 may not only have a smoother surface, but better wear behavior and better self-lubricating properties. Based on the thought that the coating 1 may be arranged on top of the substrate with the surface, the outermost fine-grained surface layer “covers” the surface in any substrate surface location above which the outermost surface area is present. The outermost surface area does not need to contact the surface of the substrate in order to “cover” said surface in the described sense.

In various embodiments, the graphite particles, particularly of the outermost fine-grained surface layer and/or the fine-grained layer, may exhibit a nano-scale size, which means that an average particle size is at least below 1000 nanometers and/or at least above 1 nanometer, in particular below 750, 500 or 250 nanometers. The graphite particles are extended and/or distributed generally in parallel to the surface and/or at least one of the fine-grained layers. The graphite particles may as well be extended along, (for example, in parallel to), at least one of the layers and/or the surface for an increased presence of the lubricating effect.

In various embodiments, when the lattice structure and/or crystal structure of the graphite particles is hexagonal 2H, the self-lubricating effect is enhanced and the formation of the layers including the spread generally in parallel to the surface is facilitated during the coating process. If in addition to that the lattice structure of the silver matrix shows a 3C or/and a 4H modification the wear resistance will be improved much more.

In various embodiments, the outermost fine-grained surface layer with at least one or all of the features described above related to the outermost fine-grained surface layer enables that the black finger/tray effect is eliminated and that the surface becomes smoother as opposed to the prior art coatings.

In various embodiments, the silver grains in the coarse-grained layer and/or other silver grains with epitaxial growth, such as those silver grains serving as a matrix to the fine-grained layer, may have grain orientation distribution of <311>:<111>:<220>=1:0.74:0.46. The silver grains may alternatively or additionally exhibit a matrix with a 001 and 111 texture which correlates with the 3C or/and 4H modification mentioned above. The layers of different microstructures may form advantageously with a ratio 1:10 up to 1:300.

In various embodiments, two or more (e.g. three, four or five) of the fine-grained layers, (for example, different layers), may be stacked atop the surface at least on average along a section of the surface. “Section” is meant particularly in terms of an area on the surface. Therefore, layers may be arranged locally atop each other across the surface to the outermost surface on the coating 1, wherein the layers may contact each other or are at least partially spaced apart from each other (e.g. by a further layer, further grains, further particles, and/or others).

In various embodiments, the coarse-grained layer may exhibit a micro-crystalline grain size, i.e., an average grain size at least above 1 micrometer and below 1000 micrometers, in particular below 10 micrometers. The coarse-grained layer, and optionally a plurality of coarse-grained layers, may serve as a matrix containing the outermost fine-grained surface layer and/or the fine-grained intermediate layers. The larger grains can provide e.g. ductility in contrast to the hardness from the fine-grained layers contained in and/or surrounded by the coarse-grained layer.

In various embodiments, below the coarse-grained layer is provided an (fine-grained) adhesion layer out of or including: Sn and/or Pd and/or Ag and/or Ni and/or Fe and/or a Cu-flash may be deposited, in particular directly on the substrate. The coarse-grained layer therefore may be located above the adhesion layer. In particular, the adhesion layer may be located below the coarse-grained layer located closest to the surface of the substrate and/or below at least essentially each, in particular below more than 80% or 90%, of the coarse-grained layers. The adhesion layer may be part of the coating 1 or may be part of the substrate. The adhesion layer may advantageously support the mechanical properties of the coating 1 in that the coating 1 (or relative to the adhesion layer the rest of the coating 1) connects better to the substrate via the adhesion layer. There may be less risk of delamination of the coating 1.

In an embodiment, a coating 1 on a surface of a substrate is provided designed to transmit electrical current in an automotive plug connection for charging an EV-battery, such as with an automotive charging connector including a charging inlet and/or a charging gun, and having layers of different microstructures and performances which extend generally in parallel to the surface. The coating 1 includes at least one fine-grained layer containing silver grains exhibiting a nano-crystalline grain size, i.e., an average grain size below 1000 nanometers, in particular above 1, 50 or 300 nanometers, and self-lubricating particles like Graphite and/or Nano-diamond and/or Graphene and/or CNT's, Lead (Pb), Molybdenum (Mo), Mo-Sulfide, Ag-Sulfide, W-Sulfide, Polytetrafluoroethylene (PTFE) or Carbon Fluoride (CFx), wherein the self-lubricating particles have a particle size less than 1000 nanometers, in particular above 1, 50 or 300 nanometers. The coating 1 includes at least one coarse-grained layer located adjacent to the fine-grained layer and containing predominantly or exclusively silver grains exhibiting a grain size which is on average larger than that of the fine-grained layer.

In various embodiments, the self-lubricating particles may replace or be supplemented by graphite particles. The self-lubricating particles as described above are beneficial for a low coefficient of friction of the coating 1, resulting in less wear of the coating 1 during use. This coating 1 may make use of any of the features and advantages, especially in applications, mentioned above.

In various embodiments, an electric charging contact is provided for use in an automotive plug connection with/using an automotive charging inlet and/or a charging gun making the charging connection having a substrate out of copper or copper alloys or Al- or Al-alloys with a coating 1 such as one of the coatings described above is used.

Optionally, the contact may make use of any of the features and advantages, especially in part, and be used in applications as mentioned above.

In various embodiments, the substrate may have copper or a copper alloy or Al- or a Al-Alloy, so that good electrical conductivity is given at acceptable cost (versus a silver alloy).

In various embodiments, the substrate may be, at least partially, rotationally symmetric and/or flat, in particular so that the connection can be realized by mating in rotational barrel/socket or flat receptacle positions, where at least one or both of two corresponding electric charging contacts may be connected with a flat or a round cable, especially by bolting and/or welding.

In various embodiments, an automotive charging connector with at least one of the above-described electric charging contacts is used. The charging connection may include a charging inlet and/or a charging gun and may be used in an automotive plug connection for charging an EV-battery.

In various embodiments, in a case of two or more contacts, the contacts may be extended parallel to each other so that a mating of corresponding electric charging contacts is facilitated and so that there is less friction on the coating 1.

In various embodiments, the automotive charging connector may include a housing holding the contact or contacts. The housing may consist of and/or be made from polymer/resins. The housing may serve as an electrical isolator and/or protector for the contact and can in addition be completed/complemented by a shielding out of metal.

In various embodiments, the automotive charging connector may include an additional housing and/or an additional active and/or passive cooling element.

The additional housing may serve to further protect the electric charging contacts. The cooling element may prevent overheating and/or derating.

In various embodiments, the housing and/or additional housing may surmount and/or overtop at least one of the electric charging contacts in a or the mating direction in order to avoid damage to the electric charging contacts, e.g. from unwanted collisions, and in order to enhance security.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

What is claimed is:

1. A coating on a surface of a substrate for transmitting electrical current in an automotive plug connection for charging an EV-battery, the coating comprising:
layers of different microstructures and performances which extend at least essentially in parallel to the surface,
the layers including at least one fine-grained intermediate layer containing silver grains exhibiting a nano-crystalline grain size having an average grain size below 1000 nanometers and containing graphite particles;
the layers including at least one coarse-grained layer located adjacent to the fine-grained layer and containing silver grains exhibiting a grain size which is on average larger than that of the fine-grained layer.

2. The coating according to claim 1, further comprising at least one outermost fine-grained surface layer containing silver grains.

3. The coating according to claim 2, wherein silver grains of the outermost fine-grained surface layer exhibiting a nano-crystalline grain size having an average grain size below 1000 nanometers.

4. The coating according to claim 2, wherein the outermost fine-grained surface layer includes graphite particles.

5. The coating according to claim 2, wherein the outermost fine-grained surface layer covers the surface with an areal fraction of at least 10%.

6. The coating according to claim 1, wherein the graphite particles have a nano-scale size having an average size below 250 nanometers in the at least one fine-grained intermediate layer.

7. The coating according to claim 6, wherein the silver grains in the at least one fine grained intermediate layer have a nano-crystalline grain size having an average size above 300 nanometers.

8. The coating according to claim 1, wherein the graphite particles are extended essentially along the at least one fine-grained intermediate layer parallel to the surface.

9. The coating according to claim 1, wherein a crystal structure of the graphite particles is hexagonal graphite 2H.

10. The coating according to claim 1, wherein, on average along a section of the surface, two of the layers are stacked atop the surface.

11. The coating according to claim 1, wherein the at least one coarse-grained layer exhibits a micro-crystalline grain size having an average grain size above 1 micrometer and below 5 micrometers.

12. The coating according to claim 1, wherein the at least one course-grained layer contains predominantly silver grains.

13. The coating according to claim 1, wherein the at least one coarse-grained layer includes an adhesion layer containing at least one of Ag, Ni, Pd, Fe, Sn and/or a Cu-flash deposited directly on the surface of the substrate.

14. The coating according to claim 1, wherein the at least one fine-grained layer contains self-lubricating particles including at least one of: Nano-diamond, Lead (Pb), Molybdenum (Mo), Mo-Sulfide, Polytetrafluoroethylene (PTFE), carbon nanotubes (CNT's), Graphene, Ag-sulfide, W-sulfide and Carbon Fluoride (CFx).

15. The coating according to claim 14, wherein that at least one coarse-grained layer contains self-lubricating particles including at least one of: Nano-diamond, Lead (Pb), Molybdenum (Mo), Mo-Sulfide, Polytetrafluoroethylene (PTFE), carbon nanotubes (CNT's), Graphene, Ag-sulfide, W-sulfide and Carbon Fluoride (CFx) exhibiting a grain size which is on average larger than that of the self-lubricating particles of the at least one fine-grained layer, the at least one course-grained layer having fewer and bigger self-lubricating particles than the at least one fine-grained layer

16. An electric charging contact for use in an automotive plug connection comprising:
a substrate having a surface; and
a coating on the surface, the coating including layers of different microstructures and performances which extend at least essentially in parallel to the surface,
the layers including at least one fine-grained intermediate layer containing silver grains exhibiting a nano-crystalline grain size having an average grain size below 1000 nanometers and containing graphite particles;
the layers including at least one coarse-grained layer located adjacent to the fine-grained layer and containing silver grains exhibiting a grain size which is on average larger than that of the fine-grained layer.

17. The electric charging contact according to claim 16, wherein the substrate includes at least one of copper, a copper alloy, aluminum, and aluminum-alloy.

18. The electric charging contact according to claim 16, wherein the substrate is one of at least partially rotationally symmetric or flat.

19. An automotive charging connection for charging a battery of an electric vehicle, the automotive charging connection comprising:
one of a charging inlet configured to be fixed to the electric vehicle or a charging gun configured to be plugged into a charging inlet of the electric vehicle; and
an electric charging contact held by the one of the charging inlet or the charging gun, the electric charging contact including a substrate having a surface and a coating on the surface, the coating including layers of different microstructures and performances which extend at least essentially in parallel to the surface, the layers including at least one fine-grained intermediate layer containing silver grains exhibiting a nano-crystalline grain size having an average grain size below 1000 nanometers and containing graphite particles, the layers including at least one coarse-grained layer located adjacent to the fine-grained layer and containing silver grains exhibiting a grain size which is on average larger than that of the fine-grained layer.

20. The automotive charging connector according to claim 19, wherein the one of the charging inlet or the charging gun includes a housing holding the electric charging contact, the housing being made from polymer.

21. The automotive charging connector according to claim 19, further comprising a cooling element for cooling the electric charging contact.
